(19) United States
(12) Patent Application Publication
(10) Pub. No.: US 2012/0153632 A1
(43) Pub. Date: Jun. 21, 2012

(54) VERTICAL AXIS WIND TURBINE GENERATOR

(76) Inventor: Apichat Suttisiltum, Bangkok (TH)

(21) Appl. No.: 13/393,532

(22) PCT Filed: Sep. 6, 2010
(86) PCT No.: PCT/TH10/00033

§ 371 Date: Feb. 29, 2012

(30) Foreign Application Priority Data
Sep. 8, 2009 (TH) 0901004039
Oct. 7, 2009 (TH) 0901004535

(51) Int. Cl. F03D 3/04; F03D 9/00

(52) U.S. Cl. 290/55

(57) ABSTRACT

The present invention relates to a vertical axis wind turbine generator comprising one turbine. The turbine comprises a plurality of V-shape longitudinal cup type blades mounted horizontally in one or more circulars around a rotor to received the wind mass and push the turbine to rotate, a step-up gear to increase the turbine shaft rotation speed, a generator is to be rotated by the drive shaft of step-up gear, a lift-up equipment for eliminating friction loss at the bearings while the turbine rotation to make it rotate similarly; freely floated in the air, and a set of wind velocity accelerating tunnel to increase wind mass blowing from any directions to a higher velocity than the natural instantaneous wind speed when approaching blades front. The turbine set is installed on a tower structure.

### TECHNICAL FIELD

The present invention relates to a wind turbine generator using a windmill to convert natural wind energy to rotary power and generates an electricity or drives a mechanically rotation equipment.

### BACKGROUND ART

Vertical axis wind turbine generator generates electricity utilizing wind power, which is a free natural energy, have been conventionally known. This type of wind turbine generator includes the components, generally they are similarly to the existing conventional vertical axis wind turbine generators; they are turbine blades, mounted to a rotor, a main shaft coupled to a rotor which integrally rotate with the turbine shaft, a step-up gearbox coupled vertically to the main shaft that rotates by mean of wind power received by the blades, and a generator is driven by a shaft output from the gear which altogether mounted vertically in-line by couplings to the bearings which are installed on the wind turbine tower structure. A wind turbine generator plant producing electricity may include accessories related to electrical transformer, batteries, inverter, control panel, associated wiring and control systems for tie-in to the grit of electricity distribution net work.

In the above-mentioned wind turbine generator systems shown in FIG. 1, blade patterns as shown details in FIG. 2, orientation of blades mounted to a rotor, lift-up equipments as shown in FIG. 3 and FIG. 4, and a set of wind velocity accelerating tunnel as shown in FIG. 5 and FIG. 6, are additionally provided by this present invention, attached and installed together with the other components to improve the wind mass utilization capability of the blades, eliminate the friction loss from the load of turbine set on bearings surfaces by the lift-up equipment and increase wind speed approaching wind turbine blades by the wind velocity accelerating tunnel to utilize wind force as a driving source of the generator, and thereby electricity can be generated using wind power as motive energy of the generator efficiently.

The blades as shown in FIG. 2 to be mounting around the turbine rotor are designed to six profiles of V-shaped longitudinal cup type. The wall width at both sides of blade shall be equal or different from each other and the longitudinal blade width of an upper and lower blade walls are a typical design pattern to be narrower at the blade's end. When the wind blows trough wind velocity accelerating tunnel approaching the blades front, large quantities of wind mass is compressed and accelerated into the blade cup, creating huge momentum pushing the blade and turbine's rotor to the preliminary decided direction and speed for rotating a shaft which coupled to a step-up gear and continue to drive the generator. The incline upper and the curve of the lower blade walls are designed to partially lift the turbine set while rotating, a faster wind velocity creates a higher self-lift-up force by these blade's wall design. One or more wind-bleeding open able doors shall be equipped to the upper blade wall by hinges. These doors are normally self-closed by its gravity at normal wind velocity and shall be gradually open when the wind speed exceeds the design limit to protect the turbine from any damages in the event of strong wind or storm as well as stabilize the turbine rotation at the designed rotation speed for maintaining maximum electricity generation capacity. Size and profile of blade cup, walls width, length and depth are specific designed to contribute as the key factors of turbine rotation efficiency at a wind speed. The V-shaped blade with aerodynamic design can also reduce a push-back or drag-force which resist against the moving direction of blades for turbine rotation is another key factor to increase the turbine rotation speed.

Lift-up equipments as shown in FIG. 3 and FIG. 4, either one of them is installed to lift the turbine set. The equipment shall be built to lift the rotatable base disc which is mounted to the lowest end of turbine shaft; the lift-up equipment is installed to eliminate the load or weight of the turbine set pressing on the upper bearings surfaces which the main shaft is mounted to. This lift-up method shall create frictionless of the turbine set rotation; similarly to the turbine set is floated and rotating freely in the air. The method of eliminating friction loss by the lift-up equipment in the present invention is a major factor that significantly increases the turbine rotation speed which improves the electricity generation efficiency.

The lift-up equipment as shown in FIG. 3 is constructed by a magnetic lifting method using electrical or permanent magnets attached to the top of foundation base plate and the lower surface of rotatable base disc. The same pole of magnets pair either south or north pole are installed facing each other and keep the gap between them around 0.1 millimeter or the flat donut like permanent magnets are one or multi-layers stacked-up loosely to the non-magnetic metal shaft such as stainless steel by facing different pole to each adjacent magnets.

The lowest layer is attached to the base plate and the top layer magnet is mounted to the rotatable base disc lowest end of turbine shaft, the non magnetic shaft welded to the base plate and lower surface of rotatable base disc. This method shall create high pushing forces to lift the whole turbine generator set at a maximum capacity of the magnets forces in combining to the self-lift-up force while turbine rotating, is designed to be equal to or a little greater than the turbine set weight.

The lift-up equipment as shown in FIG. 4 shall be fluid pressure-lift type, using pressurized air, any inert gases such as Nitrogen, high pressure water or hydraulic oil generated from a pump or compressor as circulating media. A fluid is circulated into the fluid inlet nozzle trough a fluid accumulator. The fluid at 2 to 8 Kilograms per square centimeter pressure shall pressurize the base tank under the rotatable base disc to push-up and lift the disc as well as the turbine set. The pressure different between both sides of disc surface is maintained to lift the turbine set for easier start-up and better speed of the turbine rotation. One Kilogram per square centimeter pressure difference between both sides of a square Meter of disc surface can lift the turbine's weight, loaded on the shaft and bearings surfaces as much as 10 Metric tons or 10,000 Kilograms. The differential pressure of fluids lifting the turbine which is always be regulated by a differential pressure controller system instrument. The differential pressure is controlled by automatically regulating the differential pressure controller, adjusting fluid supply pressure to overcome the instantaneous load of the turbine pressing on the bearings surfaces. The concept of differential pressure controller is to receive differential pressure signals from a differential pressure transmitter installed and connected by tubes from the base tank under and a gap above the rotatable disc.

A set of wind velocity accelerating tunnel is installed as shown in FIG. 5, details of walls as shown in FIG. 6, side walls, lower walls, upper walls are installed to form four rectangular cone like tunnels resulting windblown from any directions trough the large entrances of tunnels and accelerating the velocity leaving the tunnels at the smaller cross section area exits, to the blades front. When the wind path is forced to a smaller cross sectional exit area of tunnels approaching the turbine blades, its velocity can be raised up to 4 times faster than the natural instantaneous wind speed. The tunnel's walls are open able by equipped with one or more doors for bleeding out the wind mass; to maintain the tunnel exits wind velocity to the blades front in case of strong wind or storm; this open able walls are used effectively for the turbine safety and maintain uniform rotation at any natural instantaneous wind speed.

### DISCLOSURE OF THE INVENTION

The existing vertical axis wind turbine generators are related to many designs of the blades and turbines; but there very few of them can be successfully in using for economically and commercially electricity generation when they are installed at a weak wind location. There are many disadvantages of these vertical axis wind turbine generator, they are the blades and rotor set has low capability of receiving the wind force to rotate the turbine, lack of efficient drag force elimination design of blade's walls, no suitable and economically lift-up equipment is installed to reduce the friction losses on the bearing surfaces resulted from the turbine load, and no wind speed accelerating tunnel set is installed to increase the instantaneous natural wind velocity for a better performance of the electricity generation. All of these weak points are the major causes of the wind turbine generator plant scale-up limitations for most of the weak to moderate wind locations availability.

The present invention is a vertical axis wind turbine generator comprises a V-shaped blade longitudinal cup type which the blade profiles and mounting orientations to the rotor can increase the wind forces utilization significantly. The curve on a lower and the incline upper blade walls are designed for the turbine set self-lift-up purpose, the upper blade wall's open able doors are equipped for safety and stable operation, the simple and high performance lift-up equipments are installed to eliminate any friction losses, noisy, and overheated of the bearings as well as increase the turbine rotation efficiency. This present invention is also equipped with a wind speed accelerating tunnel set, it's specific designed of installing orientation and positions of tunnel's walls is to increase wind speed and eliminate any limitations of the weak wind locations which is feasible for a construction of this vertical axis wind turbine generator plant to generate electricity efficiently.

All of the above key design concepts make the turbine work at higher stability and efficiency, more safety, lower investment per kilowatt capacity, can be installed at various locations and work efficiently although at the location of weak wind between 3 to 5 meter per second of natural average annual wind speed, be easy for maintenance work, and the lower unit cost of electricity generated per kilowatt-hour when compared to most of the existing vertical axis wind turbine generators which need strong wind at least 8 meter per second.

The present turbine generator has many advantages, it can be rotated, receive maximum wind forces from any instantaneous natural wind directions. The design of a blade creates high torque at the shaft rotation to rotate the generator, generate more electricity power and lower the generating unit cost, the incline and lift-up curve of the blade walls is partially lift the turbine while the turbine rotating. Either type of the lift-up equipment is the efficiency improvement method by eliminating frictions on the bearings surfaces which are proved to increase the turbine's performance significantly. Wind speed accelerating tunnel is a simple and low cost static fixed structure without any rotating parts; the specific designed positions installed of tunnel's walls by this invention can direct the amount and high velocity of wind mass from any directions to the blades front and accelerate its speed up to four times higher than the instantaneous natural wind speed, as illustrated by the wind flow arrows shown in FIG. 1.

### SUMMARY OF INVENTION

### Technical Problem

There are one or more problems when vertical axis types are applied to use as a wind turbine generator. Those problems are small area of blades for receiving the wind force, shape of blade is not suitable for avoiding drag-force, turbine protection equipment is not installed in case of storm, working inefficiently at the weak wind location, and friction loss which resulted from turbine load is not eliminated. The impacts of these problems are low efficiency; location for wind turbine generator plant is limited because it requires strong wind to operate economically; expensive and difficult for construction or maintenance; no safety protection in case of strong wind, and high electricity generating unit cost because of high investment.

### Solution to Problem

To solve the above problems and achieve the reasonable cost of electricity generating by vertical axis wind turbine generator, the present invention provide the following solutions.

According to an aspect of the present invention, a vertical axis wind turbine generator includes a tower structure for installation of the turbine set for mounting blades attached to a rotor and coupled to a shaft, a step-up gear, lift-up equipment and a wind velocity accelerating tunnel.

According to this aspect, the blades of the turbine is designed to be V-shaped cup type with upper inclined and lower curved wall to self-lift-up the rotor, the blade is also equipped with self open able doors on the upper blade wall to be open for safety purpose when the turbine faces strong wind and storm as well as stabilizing the turbine rotation. Lift-up equipment is installed to make the easier and more efficient turbine start-up and normal rotation even though it is installed at a moderate wind location. This is a method to solve the location limitation of turbine generator plant to generate electricity power efficiently. The problem of weak wind location for installing a wind turbine generator to produce electricity efficiently and economically is also solved by another aspect of this invention by installing a set of wind velocity accelerating tunnel to increase the natural instantaneous wind speed to at least four times faster before the wind mass approaching the turbine blades front resulting the turbine generator plant can be located to produce electricity efficiently and economically at any locations which the presence of annual average natural instantaneous wind speed between 3 to 5 Meter per second.

### BRIEF DESCRIPTION OF DRAWINGS

The present invention is illustrated by way of example, and not limitation, in the figures of the accompanying drawings, wherein element having the same reference numeral designations represent like elements throughout, which are not necessarily drawn to scale and wherein:

FIG. 1 shows the whole pictures of top 1, and a front 2 views illustrating the complete present wind turbine generator equipment set comprises the various parts and equipments being installed in accordance to the present invention and prior described its installation orientation, and performance in the background art and disclosure of invention. This FIG. 1 reveals the details of all components, its functions to result the advantages of the present invention. This figure demonstrated the blades 3 and in FIG. 2, rotor 4, main shaft 5, couplings 6, step-up gear 7, generator 8, bearings 9, tower structure 10, lift-up equipment 11, FIG. 3 and FIG. 4, and wind velocity accelerating tunnel set 12, FIG. 5 and FIG. 6.

FIG. 2 shows the six cross sections and profiles details of V-shape blades 1, equal width of upper and lower blade walls 2, and upper blade wall wider than the lower blade wall 3, lift-up curved lower blade wall 4, inclined upper blade wall 5, open able doors 6 mounted on the upper blade wall, and narrower wall's width at the blade end as previous described the functions of blade in utilizing the wind force to rotate the turbine's rotor efficiently.

FIG. 3 shows the assemblies of the magnet type lift-up equipment which shall be utilized the pushing forces of the electrical or permanent magnets in combining to self-lift-up blade walls designed to lift the whole set of turbine up just above the bearing surfaces resulting frictionless and freely turbine set rotation. The advantage of this maintenance free lift-up equipment is its simple construction and installation and assembled from none of rotating parts which required little maintenance. These components are magnets 1, base foundation 2 under rotatable base disc 3 mounted to the lower end of turbine's shaft 4, magnets attached to base foundation in single or multi-layer and a single layer to rotatable base disc.

FIG. 4 shows the systems and assemblies of fluid type lift-up equipment which functions similar to the above lift-up equipment as illustrated in FIG. 3, the different method of them is this lift up equipment shall comprise both static equipment such as tanks 1, 2, pipes 3 and pipes fittings, and some of rotating equipment such as pumps or compressors 4, associated control valve 5 and controller 6 to control the pressure different for lifting the turbine set simultaneously.

FIG. 5 and FIG. 6 show the details of a wind speed accelerating tunnel, its installation and construction patterns of walls positions is to perform a function of increasing the wind velocity, blowing from any directions as the arrows trough tunnels narrower cross sectional area between its entrances and exits. The wind speed can be accelerated up to four times faster than the natural instantaneous wind velocity and push the blades and turbine to rotate easier and faster. The side walls 1 are located at specific designed positions 2, angles and orientations to receive the maximum wind mass from all directions at any times. The details of FIG. 5 and FIG. 6 demonstrate the whole picture, front 3 and top 4 views of tunnels, four side walls, four upper walls 5, four lower walls 6, in combining to the turbine to proof that the wind mass is accumulated and approaching turbine blades as arrows 13 shown in FIG. 1 which is only 2 parts of both side walls from the whole 4 parts from the other 2 of upper and lower walls. The path of the blade rotation in counter wind direction behind the side walls is to prevent the drag force of blade from the wind which the wall perform the function of blocking the wind blow and deviate the direction to the tunnel front of side wall to push the blades. Details of open able doors as shown in FIG. 6, equipped to the side walls 1 and upper walls 2, no door is attached to lower wall. All doors are installed stoppers 3 to limit maximum open of them.

### BEST MODEL FOR CARRYING OUT THE INVENTION

The details design concept of the vertical axis wind turbine generator as previous described and in accordance to the present invention, with reference to the drawings shall be expressed the best model below:

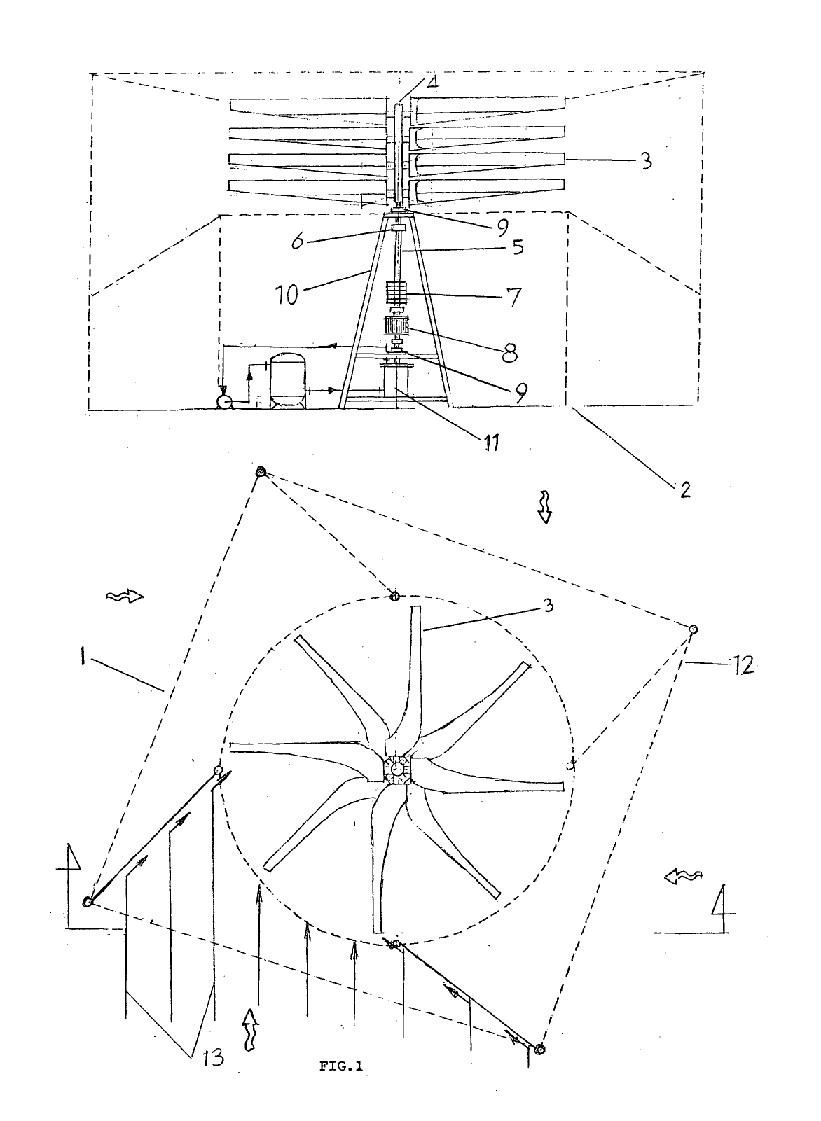

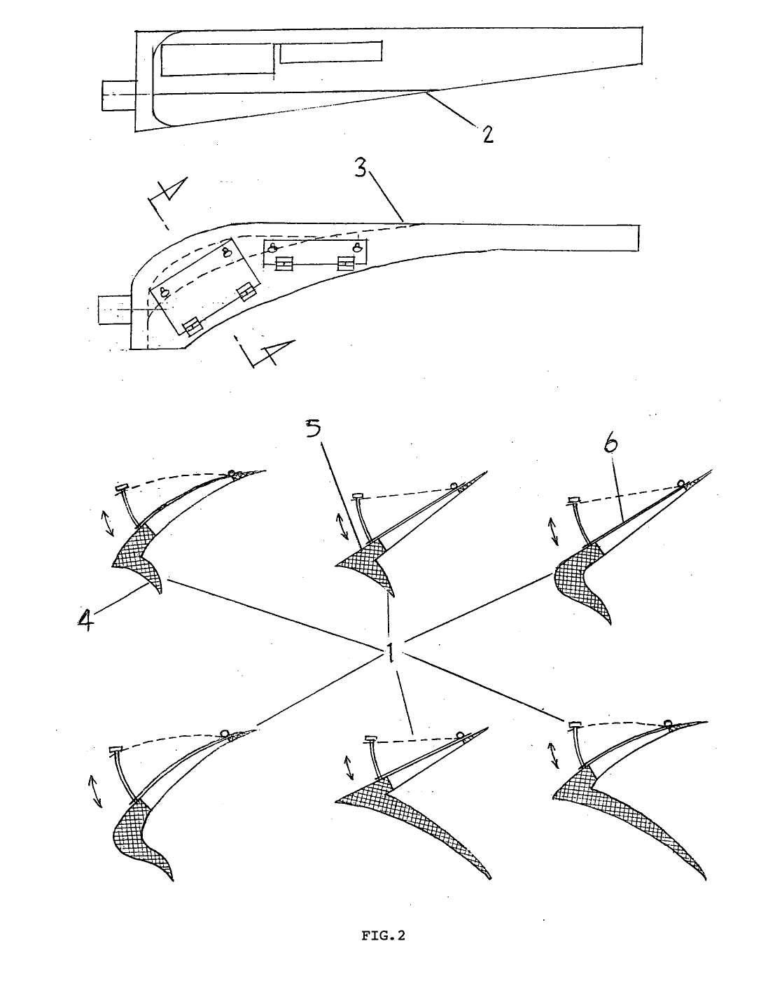

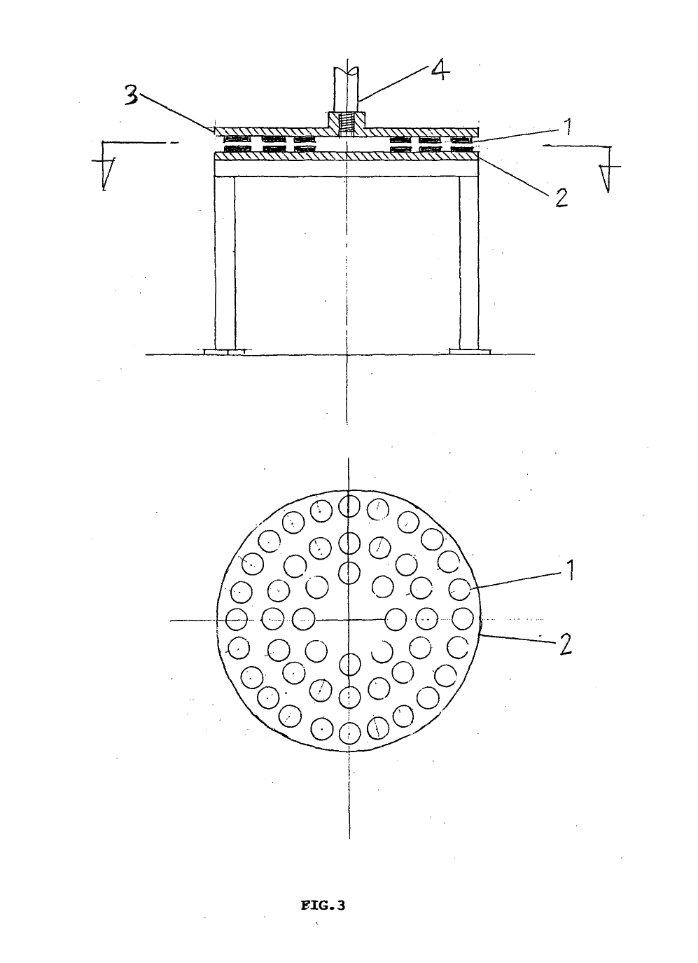

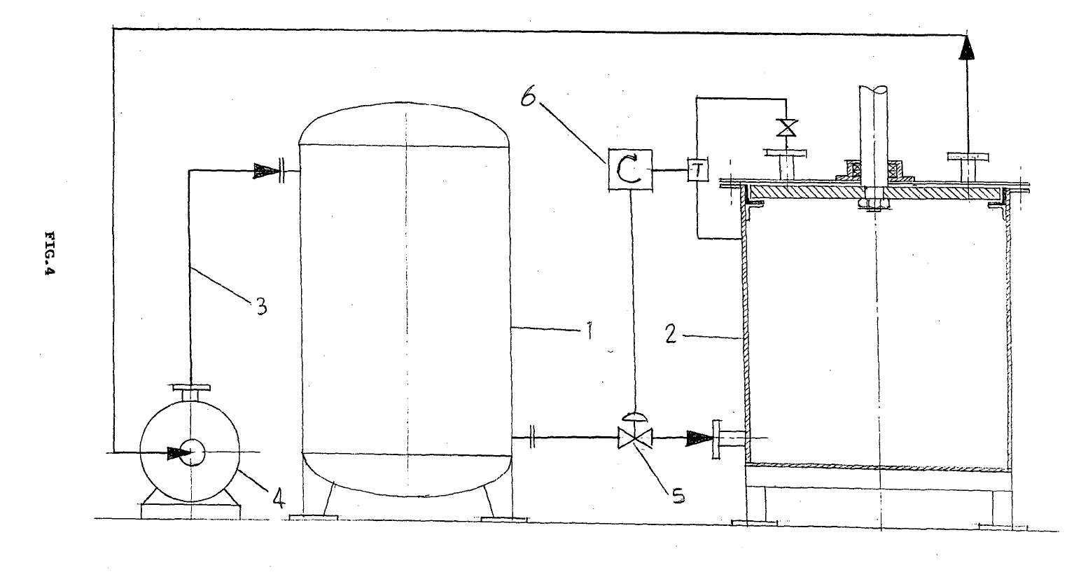

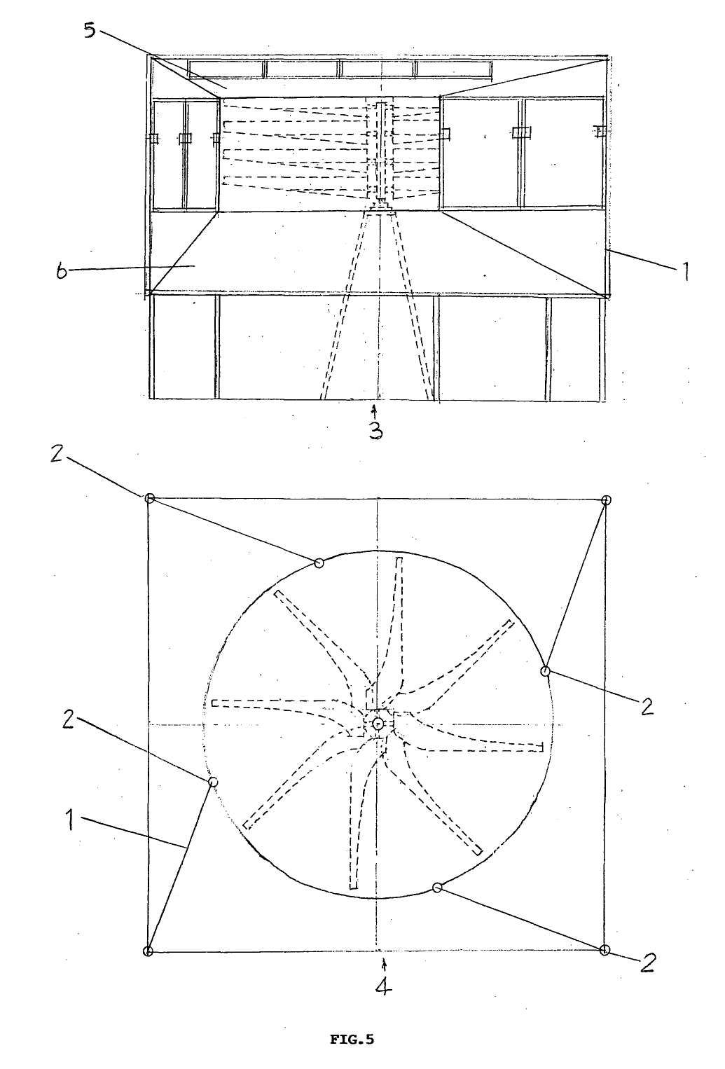

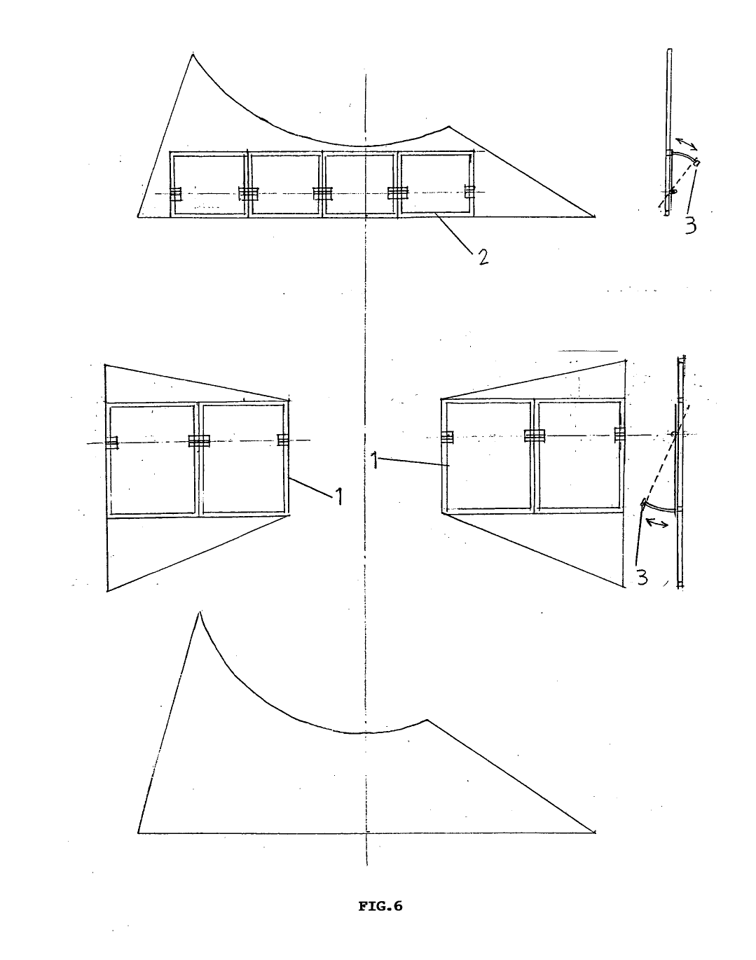

The present wind turbine generator set as shown in FIG. 1 which is equipped with components such as blades, rotor, lift-up equipments and wind speed accelerating tunnel is designed to create the best performance to rotate the turbine easier at a faster speed and a higher torque for a natural instantaneous wind velocity. The best model of the turbine shall be obtained from many factors of these design concepts, they are the shape, profiles, and mounting pattern of blades to the rotor which shall comprise the lightest, strongest, most capable in wind capturing, least wind resistant to minimize drag-force of the turbine rotating, best profile of lift-up curve and incline blade walls to perform the self-lift-up functions, and equipped open able doors to result the best turbine stabilizing and safe when a strong wind or storm occurring. The present invention includes the suitable model of lift-up equipments to lift the turbine set at an equal or a little greater instantaneous dynamic load of the whole generator set while rotating to create an easiest turbine start-up at a weak wind for a frictionless rotation. The installation of wind speed accelerating tunnel with its patterns, side walls positions, angles and orientation are the best method of increasing wind velocity up to four times faster than the natural instantaneous wind speed and blocking counter wind forces normally cause the drag-force of the blades.

### INDUSTRIAL APPLICABILITY

The present invention, vertical axis wind turbine generator can be applied to a very wide range of wind turbine to generate electricity, direct driving for mechanically rotation equipments such as pumps and compressors (air or refrigeration). It can be applied to a power plant as a standalone unit, wind farms, single or multi-unit attached between twin buildings, rooftop of a building, or any existing structure, all ranges of electrical generating capacity from 200 Watts to 10 Megawatts or larger. The lighter structure, safety design concepts of components, working efficiently and stable at moderate wind speed location are the advantages and key factors to apply this invention to transform and generate energies efficiently and economically. This present invention is also suitable for various applications in a remote area far from the power grit and electrical transmission line such as mobile phone communication tower stations and small villages, store it by battery and converted back to alternative current (A.C.) by inverter for supplying to any electrical appliances. The application of this invention to remote area by stand alone wind turbine generator or wind farm can save the cost of transmission line and substation construction, step-up, step-down transformers, eliminating power losses in the transmission line and transportation cost of fuels supplying to any fossil fuels power plants.

1. A vertical axis wind turbine converting wind energy to electricity comprising:
a vertical axis type turbine set with plurality of V-shaped longitudinal cup type blades mounted around the axis;
a rotating base disc installed at the lowest end of the turbine shaft;
a structure for installing the turbine set;
pluralities of self open-able doors mounted to the major area of upper blade wall, said doors are open by over wind speed and closed naturally by their gravity pull down at normal operation; and
a set of four ways wind velocity accelerating tunnel installed around the turbine with the tunnel ends open to the blade mounts which is a half width of the turbine rotor diameter and a step up gearbox coupled to a generator.

2-6. (canceled)

7. The vertical axis wind turbine according to claim 1 having a fluid lift-up equipment installed at the lower ends of turbine shaft axis in combining to a rotatable round disc to function as fluid bearing to lift the whole turbine set which comprising:
fluid media circulation system with associated accessories for controlling and stabilizing the turbine rotation; said system is controlled by a differential pressure controller and the fluid media using for the system can be any kinds of the followings; air, Nitrogen gas, other inert gases, any kinds of liquids such as water, hydraulic fluid or oil.

8-15. (canceled)

16. The vertical axis wind turbine according to claim 1 wherein; said the set of four ways wind velocity accelerating tunnels are equipped with large self open-able doors to cover major area of sides and upper walls of the tunnels, said doors are open by over wind force and closed naturally by gravity at normal operating condition; said tunnels having large wind flow entrances cross sectional area and small out flow cross sectional area of the exists.
